(19) United States
(12) Patent Application Publication
(10) Pub. No.: US 2005/0038150 A1
(43) Pub. Date: Feb. 17, 2005

(54) Fluoroalkyl-modified organosilanes and their use in coating compositions

(76) Inventors: Christian Meiners, Gauting (DE); Ralf Grottenmuller, Burshausen (DE); Helmut Zingerle, Garching (DE); Ivan Cabrera, Dreieich (DE)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/485,933

(22) PCT Filed: Jul. 31, 2002
(86) PCT No.: PCT/EP02/08496

(30) Foreign Application Priority Data
Aug. 2, 2001 (DE) 101379005
Aug. 22, 2001 (DE) 101410751

(51) Int. Cl. C08K 5/24; C07F 7/04

(52) U.S. Cl. 524/263; 556/485

(57) ABSTRACT

Fluoroalkyl-modified organosilanes, processes for preparing them, and their use, particularly in coating compositions for the purpose of reducing the soiling tendency of said compositions
The present invention relates to organosilanes of the general formula (I) 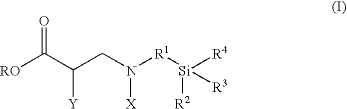
where R is a fluorinated or partly fluorinated alkyl radical of the formula CₙZ₂ₙ₊₁(CH₂)ₘ—, with n≧1, m≧1, and Z either a hydrogen atom or a fluorine atom, with the proviso that at least one Z is a fluorine atom, Y is a hydrogen atom or alkyl radical having 1 to 10 carbon atoms,
X is alternatively a hydrogen atom, a linear or branched alkyl radical having 1 to 10 carbon atoms, a radical of the formula ROC(O)(CHY)(CH₂)—, a phenyl radical or a benzyl radical,
R¹ is a linear or branched alkylene radical having 1 to 20 carbon atoms, and
R², R³, and R⁴ are linear or branched alkyl radicals having 1 to 10 carbon atoms or linear or branched alkoxy radicals having 1 to 10 carbon atoms, which are attached via the oxygen atom to the silicon atom, processes for preparing them, and their use, particularly in coating compositions for the purpose of reducing the soiling tendency of said compositions.

The present invention relates to fluoroalkyl-modified organosilanes, to processes for preparing them, and to their use, particularly as additives in coating compositions for the purpose of reducing the soiling tendency of said compositions. The resultant coating compositions also have increased water resistance in relation to coatings into which surfactantlike comparison compounds have been incorporated. Furthermore, the impregnating effect is manifested even on repeated soiling with dirt dispersions.

It is known that the addition of low molecular mass compounds containing perfluoroalkyl groups to coating compositions leads to a reduction in the soiling tendency of said compositions.

Thus U.S. Pat. No. 4,208,496 discloses dust-repellent paint compositions which include ionic emulsifiers of the formula F(CF₂)ₙCH₂CH₂SCH₂CH₂COOLi. These emulsifiers, however, have no functional groups in the molecule that could lead to anchoring in the paint film formed.

It is also known, however, that emulsifiers not chemically covalently bonded can be readily leached from coatings. Moreover, the water resistance of coatings is adversely affected by emulsifiers which are not chemically covalently bonded.

Also known are low molecular mass, silane-modified perfluoroalkane compounds of the formula CₙF₂ₙ₊₁(CH₂)₂Si(OR)₃, such as C₆F₁₃(CH₂)₂Si(OEt)₃. One of the uses of these compounds is to impregnate mineral substrates. The areas subsequently to be treated with these compounds, however, must be cleaned prior to application, and it may be necessary to repeat application of the additive. As a result of the high costs of the additive and for the multiple operations, this high-quality sealing against dirtying is very expensive. The substances are expensive owing to their synthesis by hydrosilylation, since noble metal catalysts have to be used.

JP-A-08/109580 describes the preparation of amino-containing siloxane compounds for fiber impregnation. A diamine-functionalized, oligomeric or polymeric siloxane is subjected to an addition reaction with (meth)acrylic esters. The presence of diamines, however, leads to an increase in the points of attack for oxidative degradation of the active substance molecule and to increased polarity and hydrophilicity of the compounds.

JP-A-09/279049, similarly, discloses silicon compounds composed of polymers containing silicon groups and of adducts of diaminosilanes and ethylenically unsaturated compounds containing perfluorinated or partly fluorinated alkyl radicals. As stated above, however, the skilled worker is aware that, owing to their higher polarity, diamines lead to higher water absorption and higher yellowing as compared with compounds which lack a second amine group but are otherwise constitutionally identical. Said yellowing occurs as a result of oxidative attack on the nitrogen atoms. Moreover, the complex diamines or oligoamines are more expensive to prepare than the simple aminosilanes. The presence of at least three free valences on the amino groups for adduct formation, moreover, results in the case of diaminosilanes in production of a complex product mixture, which cannot be worked up. The synthesis of a defined substance, therefore, is not economically possible. The same is true all the more for oligosilanes.

The preparation of hydrophilic organosilicon compounds by addition reaction of amino-containing silanes and/or (poly)siloxanes with (meth)acrylates modified with (oligo)hydroxy radicals or sugar radicals is described in DE-A-198 54 186. Preferably amino-organopolysiloxanes are subjected to addition reaction with the (meth)acrylic esters. A disadvantage of such additives for reducing the soiling tendency, equipped with hydrophilic radicals, however, is their increased water absorption.

Furthermore, very recent investigations have shown that the addition of siloxanes to exterior coating materials tends to increase rather than lower their soiling tendency in outdoor weathering. This is attributed, inter alia, to the increased affinity of the hydrophobic dirt components (including soot) for the hydrophobic coating (O. Wagner in “Farbe und Lack”, 2001, 107, 105-134).

It was therefore an object of the present invention to develop additives for coating compositions and polymer dispersions, for the purpose of reducing their soiling tendency, which are distinguished by moderate synthesis costs and raw materials costs and by low water absorption of the resultant coating compositions. The intention was also that the compounds should combine the advantages both of polymeric and of low molecular mass additives, namely on the one hand a high migration capacity during film consolidation, in order to permit accumulation of the hydrophobic groups at the hydrophobic air/coating interface, and on the other hand that the additives should have an increased resistance toward leaching by rain in the coating, as is achieved by polymeric, fluorinated impregnating additions.

The present invention provides organosilanes of the general formula (I) 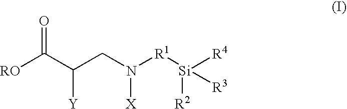
where R is a fluorinated or partly fluorinated alkyl radical of the formula CₙZ₂ₙ₊₁(CH₂)ₘ—, with n≧1, m≧1, and Z either a hydrogen atom or a fluorine atom, with the proviso that at least one Z is a fluorine atom,
Y is a hydrogen atom or alkyl radical having 1 to 10 carbon atoms,
X is alternatively a hydrogen atom, a linear or branched alkyl radical having 1 to 10 carbon atoms, a radical of the formula ROC(O)(CHY)(CH₂)—, a phenyl radical or a benzyl radical,
R¹ is a linear or branched alkylene radical having 1 to 20 carbon atoms, and
R², R², and R⁴ are linear or branched alkyl radicals having 1 to 10 carbon atoms or linear or branched alkoxy radicals having 1 to 10 carbon atoms, which are attached via the oxygen atom to the silicon atom.

Preferred organosilanes are those of the general formula (I) where R is a fluorinated alkyl radical of the formula CₙF₂ₙ₊₁(CH₂)ₘ—.

Additionally preferred organosilanes are those of the general formula (I) where n=1 to 30 and m=1 to 4.

Further preferred organosilanes are those of the general formula (I) where
X is a methyl, an ethyl, a propyl, a phenyl or a benzyl radical,
Y is a hydrogen atom or a methyl radical,
R¹ is a —(CH₂)₃—, a —CH₂CH(CH₃)CH₂— or a —C₂H₄— radical, and
R², R³, and R⁴ are a CH₃O—, a C₂H₅O— or a CH(CH₃)₂O— radical.

Particularly preferred organosilanes are those of the general formula (I) where
R is a fluorinated alkyl radical of the formula CₙF₂ₙ₊₁(CH₂)ₘ—, with n=6 to 14 and m=2. Alkyl radicals of this formula, with n=6 to 14 and m=2, constitute the best compromise between synthesis costs and raw materials costs, (unwanted) crystallization tendency of the fluoroalkane chain, and impregnating effect. Where (meth)acrylic esters having fluoroalkane residues of the stated fraction containing an ethyl spacer to the oxygen ester bond are used as a coupling component, the resultant fluoro-alkylsilanes are liquid at room temperature and hence easy to incorporate into coating compositions or latex dispersions.

Of particular preference are organosilanes of the general formula (I) where
X is an ethyl radical,
Y is a hydrogen atom or a methyl radical,
R¹ is a —CH₂CH(CH₃)CH₂— radical, and
R², R³, and R⁴ are a CH₃O— radical; or
X is a methyl radical,
Y is a hydrogen atom or a methyl radical,
R¹ is a —(CH₂)₃— radical, and
R², R³,and R⁴ are a CH₃O— radical.

The organosilanes of the invention are both hydrophobic and oleophobic and contain no siloxane groups. The sole silicon functionality of the organosilanes of the invention, the silane group, serves to anchor the hydrophobic and oleophobic fluoroalkyl group on the substrate.

The present invention further provides processes for preparing the organosilanes of the invention.

The organosilanes of the invention are prepared preferably by an addition reaction, similar to the Michael reaction, of ω-aminoalkylsilanes by the amino group onto the double bond of the (meth)acrylic esters with a fluorinated side chain. By (meth)acrylic esters are meant here both the esters of acrylic acid and the esters of methacrylic acid.

The present invention accordingly also provides a process for preparing the organosilanes of the invention which is characterized in that a (meth)acrylic ester of the general formula (II) is reacted with an ω-aminoalkylsilane of the general formula (III), 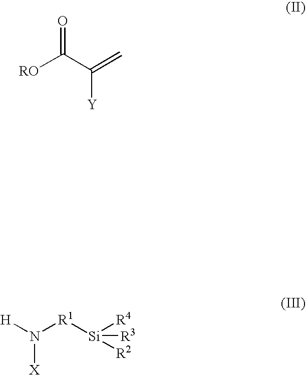
where R is a fluorinated or partly fluorinated alkyl radical of the formula CₙZ₂ₙ₊₁(CH₂)ₘ—, with n≧1, m≧1, and Z either a hydrogen atom or a fluorine atom, with the proviso that at least one Z is a fluorine atom,
Y is a hydrogen atom or alkyl radical having 1 to 10 carbon atoms,
X is alternatively a hydrogen atom, a linear or branched alkyl radical having 1 to 10 carbon atoms, a radical of the formula ROC(O)(CHY)(CH₂)—, a phenyl radical or a benzyl radical,
R¹ is a linear or branched alkylene radical having 1 to 20 carbon atoms, and
R², R³, and R⁴ are linear or branched alkyl radicals having 1 to 10 carbon atoms or linear or branched alkoxy radicals having 1 to 10 carbon atoms, which are attached via the oxygen atom to the silicon atom.

The reaction takes place either without solvent or with the addition of water, organic solvents or mixtures thereof. The reaction takes place preferably under atmospheric pressure (1 bar) but may also be conducted under increased or reduced pressure. It is additionally possible to use catalysts, accelerating the reaction.

Where a solvent is used for the preparation, either the reaction product is used in the reaction solvent or the solvent used is removed. If desired, the product obtained, following the removal of the solvent, can be dissolved in another solvent, or dispersed in water or a different liquid. Emulsifiers can be used for this purpose.

A further preferred subject matter of the present invention relates to the use of the organosilanes of the invention, particularly in coating compositions, for the treatment of surfaces in order to reduce their soiling tendency.

The organosilanes of the invention additionally find use as antiblocking agents, especially in coating compositions (e.g., varnishes for coating wood) and polymer dispersions.

A further subject matter of the present invention relates, accordingly, to the use of the organosilanes of the invention as antiblocking agents, particularly in coating compositions, for the treatment of surfaces.

It has in fact surprisingly been found that the organosilanes of the invention as additives in polymer dispersions significantly increase the blocking resistance, i.e., the resistance to sticking to similarly treated surfaces or other surfaces, of the coatings which result therefrom. For example, in the case of styrene-acrylate dispersions with a core-shell morphology, which normally exhibit moderate blocking resistance in the varnish film on wood substrates, even very small amounts of the organosilanes of the invention (e.g., 0.5% by weight) lead to excellent blocking resistances (blocking propensity with respect to similarly treated surfaces, determined at 50° C. and room temperature).

Likewise provided by the present invention is the use of the organosilanes of the invention for the hydrophobicization and oleophobicization of surfaces.

For all end uses the coating of the surfaces takes place preferably by spraying the organosilanes of the invention as they are, in solution or in dispersion onto the surfaces to be treated, immersing the surface into the solution or dispersion of the additives, or applying said organosilanes with a brush or by roller, or adding them to a coating composition intended for application and comprising at least one polymeric binder, as they are, in solution or in dispersion, and applying the coating composition to the surface.

Also possible is the use of the additives of the invention as release agents for surfaces.

The present invention also provides, however, the coating compositions themselves.

Preference is given here to coating compositions comprising
a) at least one polymeric binder,
b) at least one organosilane of the invention, and also
c) if desired, pigments, fillers, dispersants, thickeners, protective colloids, wetting agents, preservatives, algicides, anticorrosion pigments, UV filter substances, UV initiators and/or further auxiliaries.

The coating composition here comprises the polymeric binder (or binders) in solution, dispersion or emulsion in liquids, or as it is (the latter in the case, for example, of powder coating materials as coating composition). As polymeric binders it is possible to use any polymeric binders known to the skilled worker. Preferred polymeric binders are poly(acrylates), poly(styrene acrylates), poly(urethanes), poly(esters), polyesterpolyols, amino resins, epoxy resins, epoxyamine resins, alkyd resins, hybrid dispersions of poly(styrene acrylates) or poly(acrylates) with poly(urethanes) and/or alkyd resins. Mixtures of these polymers can also be used.

With particular preference the organosilanes of the invention are used for reducing the early soiling tendency in pigmented exterior coatings with polymeric binders comprising UV initiators (such as benzophenone derivatives, for example). The UV initiator can either be present in the polymeric binder or added to the coating composition during its preparation. Preferred applications of these coatings include, for example, elastic exterior coatings and traffic marking paints.

Particular preference is therefore given to coating compositions further comprising at least one UV initiator.

The dirt-repellent organosilanes migrate to the surface of the coating composition or polymer film and prevent sticking of the soft, polymeric binder to dirt particles until the UV initiators have brought about superficial hardening of the polymeric binder. Indeed, depending on insolation, a considerable time may pass before the UV initiator has hardened the surfaces of the coatings.

Additionally, after they have migrated to the surface of the coating composition or polymer film, the reactive groups of the organosilane react with the reactive groups of the polymer and possibly, where present, with the reactive groups of the pigments and/or fillers. By this means it is possible to prevent the organosilane being leached from the surface of the coating.

It has surprisingly been found, moreover, that the dirt-repellent effect of the organosilanes of the invention is intensified if they are used in coating compositions (including varnishes) which comprise polymer dispersions which include ethylenically unsaturated ω-hydroxyalkyl acrylates or ω-hydroxyalkyl methacrylates (such as 2-hydroxyethyl methacrylate, for example) in conjunction with epoxyalkylsilanes (e.g., β-(3,4-epoxycyclohexyl)ethyltriethoxysilane or γ-glycidyloxypropyltrimethoxysilane).

In another preferred embodiment the at least one polymeric binder of the coating composition of the invention includes at least one ω-hydroxyalkyl (meth)acrylate as monomeric building block (comonomer) and at least one epoxyalkylsilane of the formula BSiR₃, where the radical B is an organic radical having at least one oxirane functionality and the radicals R are alkyl or alkoxy groups of the formula —CₙH₂ₙ₊₁ or —OCₙH₂ₙ₊₁ respectively, in which n=1 to 10.

A particularly preferred ω-hydroxyalkyl (meth)acrylate used is 2-hydroxyethyl methacrylate and a particularly preferred epoxyalkylsilane used is β—(3,4-epoxycyclohexyl)ethyltriethoxysilane or γ-glycidyloxypropyltrimethoxysilane.

Where the organosilanes are used in coating compositions, they can either be added directly to the polymeric binder (in solution or dispersion) or else added during the production of the coating and/or the preparation of the paint.

Where the additives are used directly for impregnating surfaces, they are preferably applied in solution or dispersion.

The present invention is described in more detail below, with reference to examples, though without being restricted by said examples.

A) Description of the Analysis Methods:

The hydrophobicity, oleophobicity, and dirt-repellent effect of the impregnated surfaces were determined as follows:

Determination of Water Absorption:

9 g of demineralized water are added to 15 g of coating composition and the mixture is poured onto the underside of a plastic beaker with stand rim (approximately 11 cm in diameter). The coating film is dried at room temperature for 7 days, during which it is detached daily and turned once. Then test specimens measuring 3×3 cm are cut from the film and detached from the substrate. The films are weighed (in duplicate) and then stored in water in a Petri dish for 24 hours. The water is then dabbed off with a cellulose cloth and the film is weighed again. The weight increase in percent over the initial weight corresponds to the first water absorption. The test specimens are then dried for 2 days and the film is subsequently weighed, water-exposed for 24 hours, dabbed off with a cellulose cloth, and weighed again. The second water absorption, in percent, is determined in the same way as for the first.

Determination of Blushing (Water Susceptibility):

The dispersion is knife-coated to a glass plate (5×8 cm) using a 200 μm box-type bar coater and dried at 40° C. for one hour and then dried further overnight at room temperature. The sample is then placed in a Petri dish filled with deionized water and after about 15 minutes the blushing of the polymer film is evaluated on a relative scale from 1 to 5 (1=very good, 5=deficient).

Determination of Dry Soiling Tendency:

The coating is applied to a glass plate using a 200 μm box-type bar coater and stored in a climate chamber at 23° C. and 50% relative humidity for 24 hours. Then, using an Erichsen Colorimeter model 526 (measuring geometry 45°/0°), the lightness L* in the CIELAB color system is measured against an external white standard (L*=94.33). Using a dry brush, fly ash or a mixture of 99.5 parts by weight fly ash and 0.5 part by weight soot is rubbed into the sample plate, which is then vigorously brushed with the brush. The measurement of the lightness L* is repeated with the soiled plate. The difference from the original L* value is referred to subsequently as ΔL*.

Determination of Wet Soiling Tendency:

Sample preparation is as for the dry soiling tendency, but the substrate used is a fiber cement sheet, Eterplan 300×150×4 mm. The wet thickness of the film is 300 μm. After the L* value has been measured (Erichsen Colorimeter 526, see above) the dried sample is fixed with the coating pointing upward on a support above a drip tray, at an inclination of 60° with respect to the horizontal.

500 ml of an aqueous dispersion of standard dirt are then circulated over the sample using a peristaltic pump. This pump delivers approximately 500 ml/min. The dirt dispersion running off is collected in the tray and passed over the sample again. The dispersion is stirred with a magnetic stirrer during this operation. After 30 minutes the cycle is interrupted and the sample is dried at room temperature for 24 hours. The lightness L* is then determined using the Erichsen Colorimeter 526. Subsequently the sample is again subjected to soiling and drying cycles. Each time the L* value is determined after the drying cycle. The βL* value is obtained therefrom in each case by the difference from the original L* value prior to soiling. For each cycle a fresh dirt solution is used. The dirt solution is prepared as follows:

17 g of gas black FW 200, 70 g of Japanese standard dust No. 8, and 13 g of special pitch No. 5 (from Worlee) are weighed out into a 1000 ml powder bottle and 400 cm³ of glass beads are added. The mixture is mixed on a roller bed for 24 hours and the glass beads are removed by sieving. The powder is homogenized using a mortar and pestle. 1 g of standard dirt powder is introduced together with 1 g of butyl glycol into a glass vessel and 998 g of water are added. The dispersion is stirred with a magnetic stirrer.

### B) DESCRIPTION OF THE EXAMPLES

### Example 1

### Preparation of the Fluoroalkyl-modified Organosilanes

The course of the reaction is monitored analytically by way of the amine number and by way of ¹H—NMR from the intensities of the protons of the acrylate double bond.

a) Product A

50 g of Silquest® A-Link 15 (N-ethyl-3-trimethoxysilyl-2-methylpropanamine, Crompton) and 125 g of Fluowet® AC 812 (CH₂ =CHCOOCH₂CH₂(CF₂CF₂)ₙF, n=3 to 6, Clariant) are reacted in a 250 ml flask under an N₂ atmosphere at 75° C. with stirring for 6 hours. Cooling to room temperature gives 175 g of the product in the form of an orange-brown mass, with solid and liquid fractions.

b) Product B

50 g of Silquest® A-Link 15 and 117 g of Fluowet® AC 800 (CH₂=CHCOOCH₂CH₂(CF₂CF₂)₄F, Clariant) are reacted in a 250 ml flask under an N₂ atmosphere at 75° C. with stirring for 6 hours. Cooling to room temperature gives 167 g of the product in the form of a partly crystalline, partly still fluid, orange-brown mass.

c) Product C

50 g of Silquest® A-Link 15 and 125 g of Fluowet® AC 812 are reacted in a 500 ml flask under an N₂ atmosphere in 150 g of anhydrous butyl acetate at 75° C. with stirring for 8 hours. Cooling to room temperature gives 325 g of the product in the form of a clear, orange-colored solution.

d) Product D

30 g of Silquest® A 1100 (3-triethoxysilyl-1-propanamine, Crompton) and 153 g of Fluowet® MA 812 are reacted in a 250 ml flask under an N₂ atmosphere at 75° C. with stirring for 10 hours. Cooling to room temperature gives 183 g of the product in the form of a partly crystalline, partly still fluid, orange-brown mass.

e) Product E

40 g of Silquest® A 1100 and 152 g of Fluowet® AC 600 (CH₂=CHCOOCH₂CH₂(CF₂CF₂)₃F, Clariant) are reacted in a 500 ml flask under an N₂ atmosphere in 150 g of anhydrous butyl acetate at 75° C. with stirring for 8 hours. Cooling to room temperature gives 342 g of the product in the form of a clear, yellow-orange-colored solution.

f) Product F

50 g of Silquest® A 1100 and 142 g of Fluowet® AC 600 are reacted in a 500 ml flask under an N₂ atmosphere in 150 g of anhydrous butyl acetate at 75° C. with stirring for 8 hours. Cooling to room temperature gives 342 g of the product in the form of a clear, yellow-orange colored solution.

TABLE 1

| | Product A | Product B | Product C | Product D | Product E | Product F |
|---|---|---|---|---|---|---|
| Aminosilane | A-Link 15 | A-Link 15 | A-Link 15 | A 1100 | A 1100 | A 1100 |
| Fluoroacrylate | AC 812 | AC 800 | AC 812 | MA 812 | AC 600 | AC 600 |
| Ratio* | 1:1 | 1:1 | 1:1 | 1:2 | 1:2 | 1:1.5 |
| Solvent | — | — | butyl | — | butyl | butyl |
| | | | acetate | | acetate | acetate |

*molar ratio of aminosilane to fluoroacrylate

### Example 2

### Production of Elastic Masonry Coatings

Added to 100 g of water in succession with stirring are 5 g of a 10% strength solution of Calgon® N and 1.4 g of Coatex® P 90 and also 2 g of Foammaster® 111 FA. Then 80 g of titanium dioxide (Kronos® L 2310) and 380 g of calcium carbonate (Durcal® 2) are added in succession and the mixture is stirred with a dissolver at 5000 rpm for 15 minutes. Subsequently 382.3 g of a dispersion (solids content approximately 60%) are added at 500 rpm, and also 1 g of 20% strength aqueous ammonia, and the mixture is stirred for 5 minutes. Finally 2 g of Mergal® K9, 2 g of butyl diglycol, 10 g of propylene glycol, 5 g of White Spirit® 17/18 and, to finish, a solution of 7.5 g of Coatex® BR 100 and 23.2 g of water are added. The mixture is then stirred further for about 5 minutes more.

Before being used, the paint is stored for at least one more day at room temperature.

The following additive is added to the dispersion before it is added to the colorant paste:

TABLE 2

| | | Additive/added |
|---|---|---|
| | | amount of |
| | | active substance |
| | | in % by weight |
| Example | Dispersion | based on dispersion |
| a | Mowilith ® LDM 7977 (Clariant) | —/— |
| b | Mowilith ® LDM 7977 (Clariant) | Fluowet ® OTL/0.1 |
| c | Mowilith ® LDM 7977 (Clariant) | Zonyl ® FSA/0.1 |
| d | Mowilith ® LDM 7977 (Clariant) | Example 1a/0.1 |
| e | Mowilith ® LDM 7977 (Clariant) | Example 1b/0.1 |
| f | Mowilith ® LDM 7977 (Clariant) | Fluowet ® OTL/0.2 |
| g | Mowilith ® LDM 7977 (Clariant) | Zonyl ® FSA/0.2 |
| h | Mowilith ® LDM 7977 (Clariant) | Example 1a/0.2 |
| i | Mowilith ® LDM 7977 (Clariant) | Example 1b/0.2 |

### Example 3

### Determination of the Dry Soiling Tendency of the Masonry Coatings

Soiling was effected using the fly ash/soot mixture described above in the

context of the measurement methods.

TABLE 3

| Coating material | ΔL* |
|---|---|
| Example 2a | 26.4 |
| Example 2b | 24.5 |
| Example 2d | 23.6 |

As is apparent from table 3, even very small added amounts show a distinct improvement in the dry soiling tendency.

### Example 4

### Determination of the Water Absorption of the Masonry Coatings

TABLE 4

| Coating material | 1st water absorption [%] | 2nd water absorption [%] |
|---|---|---|
| Example 2a | 17.4 | 10.6 |
| Example 2f | 18.7 | 12.1 |
| Example 2h | 15.4 | 10.3 |
| Example 2i | 17.0 | 9.8 |

As table 4 shows, the coatings with the organosilanes of the invention exhibit a reduced water absorption as compared with those where the addition is a non-reactive fluoroemulsifier.

### Example 5

### Determination of the Wet Soiling Tendency of the Masonry Coatings

TABLE 5

| Coating | 1st cycle | 2nd cycle | 3rd cycle | 4th cycle | 5th cycle |
|---|---|---|---|---|---|
| material | [ΔL*] | [ΔL*] | [ΔL*] | [ΔL*] | [ΔL*] |
| Example 2a | 1.1 | 2.5 | 3.7 | 4.8 | 6.0 |
| Example 2f | 1.1 | 2.7 | 3.2 | 4.4 | 5.0 |
| Example 2h | 1.1 | 1.7 | 3.1 | 4.2 | 4.4 |
| Example 2i | 0.8 | 1.3 | 3.0 | 4.0 | 3.9 |

As table 5 shows, the organosilanes of the invention lead to an improved early wet soiling tendency in the coatings, compared with additives having surfactant character but without reactive functionality.

### Example 6

Various additives for reducing the soiling tendency are added to a Mowilith® LDM 6636 (Clariant) dispersion and the mixture is homogenized with a paddle stirrer for 10 minutes. Thereafter the respective mixture is applied to a glass plate using a 300 μm box-type coater bar and dried at room temperature for 24 hours.

TABLE 6

| | Amount added | |
|---|---|---|
| | (% by weight of active substance | |
| Mixture | based on dispersion) | Blushing |
| LDM 6636/— | — | 3 |
| LDM 6636/example 1b | 0.2 | 3 |
| LDM 6636/example 1b | 5 | 2 |
| LDM 6636/Zonyl ® FSA | 0.2 | 3-4 |
| LDM 6636/Zonyl ® FSA | 5 | 5 |
| LDM 6636/Fluowet ® | 0.2 | 4 |
| OTL | | |
| LDM 6636/Zonyl ® FSA | 5 | 5 |

As table 6 shows, the organosilanes of the invention produce an increase and not, like the prior art additives, a reduction in the water resistance.

### Example 7

### Preparation of an Exterior Paint

Dissolved in succession in 130 g of water are 2 g of Tylose® MH 4000 KG 4 (Clariant), 3 g of Mowiplus® XW 330 (Clariant), 11 g of Calgon® N (10% strength by weight), and 2 g of 25% aqueous ammonia. Following the addition of 2 g of Mergal® K10ON (from Troy), 4 g of Agitan® 232 (Munzing) and then 226 g of titanium dioxide Kronos® 2065 (Kronos Titan), 168 g of Omyacarb® 5 GU, 38 g of Micro Talc AT1 and 20 g of China Clay are added and the mixture is sheared with the dissolver disk at 5000 rpm for 15 minutes. Subsequently 375 g of Mowilith® LDM 6636 (Clariant) are introduced at 500 rpm. The dispersion is admixed where appropriate with a dirt-repellent additive, which is incorporated into the dispersion beforehand using a paddle stirrer. Finally 11 g of white spirit and 8 g of butyl diglycol acetate are added and stirring is continued for about 10 minutes more.

TABLE 7

| | Additive/amount added [% by weight of active |
|---|---|
| Paint | substance, based on dispersion] |
| 7a | —/— |
| 7b | Example 1b/5 |
| 7c | Zonyl ® FSA/5 |
| 7d | Fluowet ® OTL/5 |

The paint is stored for at least one day prior to use.

### Example 8

### Measurement of the Dry Soiling Tendency of the Exterior Paint (Fly Ash with Added Soot)

TABLE 8

| Paints | ΔL* |
|---|---|
| 7a | 19.7 |
| 7b | 5.2 |
| 7c | 10.0 |
| 7d | 17.3 |

### Example 9

### Determination of the Dry Soiling Tendency (Fly Ash with Added Soot) of a Styrene-butyl Acrylate Polymer Dispersion in a Varnish

A styrene-butyl acrylate polymer dispersion prepared by emulsion polymerization in water at 80° C. (solids content: 50%, Tg: 20° C.) containing 3.8% by weight of 2-hydroxyethyl methacrylate (HEMA), based on the monomers, in copolymerized form, is admixed
a) with no additive,
b) with 0.5% by weight, based on the solids content of the dispersion, of γ-glycidyloxypropyltrimethoxysilane, and
c) with 0.5% by weight, based on the solids content of the dispersion, of γ-glycidyloxypropyltrimethoxysilane and 1% by weight, based on the solids content of the dispersion, of organosilane of example 1b, both added subsequently.

The resultant dispersion blends are applied to glass plates using a box-type coater bar (300 μm wet film thickness) and dried at room temperature for 24 hours. Then the dry soiling tendency (fly ash/soot mixture) is determined. The results are shown by table 9.

### Example 10

### Determination of the Dry Soiling Tendency (Fly Ash with Added Soot) of a Styrene-butyl Acrylate Polymer Dispersion in a Varnish

A styrene-butyl acrylate polymer dispersion of the same composition as that of example 9 but containing no 2-hydroxyethyl methacrylate is admixed
a) with no additive,
b) with 0.5% by weight, based on the solids content of the dispersion, of γ-glycidyloxypropyltrimethoxysilane, and
c) with 0.5% by weight, based on the solids content of the dispersion, of γ-glycidyloxypropyltrimethoxysilane and 1% by weight, based on the solids content of the dispersion, of organosilane of example 1b.

The resultant dispersions are applied to glass plates using a box-type coater bar (300 μm wet film thickness) and dried at room temperature for 24 hours. Then the dry soiling tendency (fly ash/soot mixture) is determined. The results are shown by table 9.

TABLE 9
Dry soiling tendencies of the styrene-butyl acrylate polymer
dispersions in a varnish of examples 9 and 10 (fly ash with 0.5%
of added soot)

| | | | | ΔL* |
|---|---|---|---|---|
| | | γ-Glycidyloxy- | | Dry soiling |
| | | trimethoxy- | Additive | tendency |
| Example | HEMA | silane | Example 1b | Fly ash/soot |
| 9a | + | − | − | 13.2 |
| 9b | + | + | − | 11.5 |
| 9c | + | + | + | 9.7 |
| 10a | − | − | − | 12.7 |
| 10b | − | + | − | 13.8 |
| 10c | − | + | + | 11.3 |

As table 9 shows, the combination of co-hydroxyalkyl (meth)acrylates, γ-glycidyloxypropyltrimethoxysilane, and the fluoroalkyl-modified organosilanes of the invention brings about an intensification of the dirtrepellent effect.

1. An organosilane of the formula 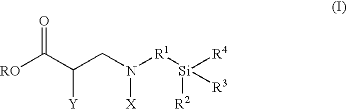
wherein R is a fluorinated or partly fluorinated alkyl of the formula CₙZ₂ₙ₊₁(CH₂)ₘ—, with n≧1, m≧1, and Z is hydrogen or a fluorine with the proviso that at least one Z is a fluorine, Y is hydrogen or alkyl of 1 to 10 carbon atoms, X is selected from the group consisting of hydrogen, alkyl of 1 to 10 carbon atoms, ROC(O)(CHY)(CH₂)—, phenyl and benzyl,
R₁ is alkylene of 1 to 20 carbon atoms, and
R², R³ and R⁴ are alkyl of 1 to 10 carbon atoms or alkoxy of 1 to 10 carbon atoms, which are attached via the oxygen atom to the silicon atom.

2. An organosilane of claim 1, wherein R is CₙF₂ₙ₊1(CH₂)ₘ—.

3. An organosilane of claim 1, wherein n=1 to 30 and m=1 to 4.

4. An organosilane of claim 1 wherein
X is selected from the group consisting of methyl, ethyl, propyl, phenyl and benzyl,
Y is selected from the group consisting of hydrogen or methyl,
R¹ is selected from the group consisting of —(CH₂)₃—, —CH₂CH(CH₃)CH₂— and —C₂H₄, and
R², R³, and R⁴ are selected from the group consisting of CH₃O—, C₂H₅O— and CH(CH₃)₂O—

5. An organosilane of claim 1 wherein n=6 and m=2.

6. An organosilane of claim 4, wherein X is ethyl,
R¹ is —CH₂CH(CH₃)CH₂—, and
R², R³, and R⁴ are CH₃O—.

7. An organosilane of claim 4, wherein X is methyl,
R¹ is —(CH₂)₃, and
R², R³ and R⁴ are CH₃O—.

8. A process for preparing an organosilane of claim 1 comprising reacting a (mety)acrylic ester of the formula 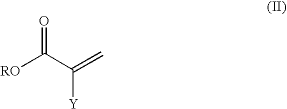
with an ω-aminoalkylsilane of the formula 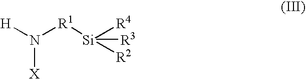
where R is CₙZ_{2n +1}(CH₂)ₘ—, with n≧1, m≧1, and Z is hydrogen or fluorine, with the proviso that at least one Z is a fluorine,
Y is a hydrogen or alkyl of 1 to 10 carbon atoms,
X is selected from the group consisting of hydrogen, alkyl of 1 to 10 carbon atoms, ROC(O)(CHY)(CH₂)—, a phenyl and benzyl,
R¹ is alkylene of 1 to 20 carbon atoms, and
R², R³, and R⁴ are alkyl of 1 to 10 carbon atoms or of 1 to 10 carbon atoms, which are attached via the oxygen atom to the silicon atom.

9-11. (cancelled)

12. A method of coating surfaces, which comprises spraying an organosilane of claim 1 as it is, in solution or in dispersion onto the surfaces to be treated, immersing the surface into the solution or dispersion of the additives, or applying it with a brush or by roller, or adding it to a coating composition to be applied, as it is, in solution or in dispersion, and applying the coating composition to the surface.

13. An organosilane of claim 1 in a coating composition for reducing the soiling tendency of surfaces.

14. An organosilane of claim 1 as an antiblocking agent in a coating composition for the treatment of surfaces.

15. An organosilane of claim 1 in a coating composition for the hydrophobicization and oleophobicization of surfaces.

16. A coating composition comprising:
a) at least one polymeric binder,
b) at least one organosilane of claim 1, and
c) optionally, at least one member of the group consisting of pigments, fillers, dispersants, thickeners, protective colloids, wetting agents, preservatives, algicides, anticorrosion pigments, UV filter substances, UV initiators and further auxiliaries.

17. A coating composition of claim 16, comprising at least one UV initiator.

18. A coating composition of claim 16, wherein the at least one polymeric binder comprises at least one ω-hydroxyalkyl (meth)acrylate as monomeric building block (comonomer) and at least one epoxyalkylsilane of the formula BSiR₃, B being an organic having at least one oxirane functionally and the Rs being —CₙH₂ₙ₊₁ or —OCₙH₂ₙ₊₁ respectively, in which n=1 to 10.

19. A coating composition of claim 18, wherein ω-hydroxyalkyl (meth)acrylate 2- hydroxyethyl methacrylate is used.

20. A coating composition of claim 18, wherein the epoxyalkylsilane is β-(3,4-epoxycyclohexyl)ethyltriethoxysilane or γ-glycidyl-oxypropyltrimethoxysilane.

21. In a method of reducing the soiling tendency of a surface, the improvement comprising using a composition containing an organosilane of claim 1.

22. In a method of treating a surface with an antiblocking agent, the improvement comprising using an organosilane of claim 1 as the said agent.

23. In a method of providing a surface with hydrophobicization or oleophobicization coating, the improvement comprising an organosilane of claim 1 in the coating.
